(19) United States
(12) Patent Application Publication
(10) Pub. No.: US 2018/0239894 A1
(43) Pub. Date: Aug. 23, 2018

(54) UNIVERSAL APPLICATION COMPOSED OF MULTIPLE UNIVERSAL APPLICATIONS

(71) Applicant: MICROSOFT TECHNOLOGY LICENSING, LLC, Redmond, WA (US)

(72) Inventors: Sarjana Sheth Mitra, Yarrow Point, WA (US); John M. Sheehan, Seattle, WA (US); John J. Vintzel, Redmond, WA (US); Jason G. Salameh, Bothell, WA (US); Carl W. Russell, Snoqualmie, WA (US); Howard S. Kapustein, Issaquah, WA (US); Paul Sliwowicz, Seattle, WA (US); Letao Wang, Bellevue, WA (US); Stephen R. Reading, Seattle, WA (US); William L. Cheng, Redmond, WA (US)

(21) Appl. No.: 15/436,732

(22) Filed: Feb. 17, 2017

(51) Int. Cl. G06F 21/52

(52) U.S. Cl. CPC G06F 21/52; G06F 2221/2149

(57) ABSTRACT

A computer-implemented method comprises executing a first application package in a runtime having a first application security context, identifying a dependency element in a second application package, and if the dependency element is associated with the first application package, then executing the second application package within the runtime and security context for the first application package. A system comprises a system memory for storing files for a main application package and files for optional application packages, wherein the optional application packages each comprise a dependency element that identifies one or more intended main application package; and a processor having a runtime and security context configured to support execution of the main application package, wherein one or more optional application packages execute on the processor within the runtime and security context with the first application package if the one or more optional application package's dependency element identifies the main application package.

### BACKGROUND

Application users want their experiences to be mobile across all of their devices, and they want to use whatever device is most convenient or productive for the task at hand. A universal platform that runs on many different devices, such as personal computers, tablets, smartphones, and game consoles, makes it easier to support a number of screen sizes, and a variety of interaction models, such as touch, mouse and keyboard, game controller, or pen. Universal applications can be written for a universal platform.

The universal applications target device families, not a particular operating system. The device family identifies the APIs, system characteristics, and behaviors that developers can expect across devices within the device family. Developers can work with familiar programming languages, frameworks, and APIs, all in single project, and have the very same code run on a wide range of hardware. Once the developer has written their universal application, they can publish it to an application store for users to access. The device family determines the set of devices on which the universal application can be installed from the store.

The universal applications are packaged and distributed using a universal platform packaging format. All universal applications are distributed as the universal platform package. This provides a trustworthy installation mechanism and ensures that the applications can be deployed and updated seamlessly.

The universal platform provides a common application platform that is available on every device. With this evolution, applications that target the universal platform can call not only the APIs that are common to all devices, but also APIs that are specific to the device family that the application is running on. The universal platform provides a guaranteed core API layer across devices. This means developers can create a single application package that can be installed onto a wide range of devices.

In current platforms, developers who want to build durable content are required to release that content within the application itself. The application logic is more complex when the developer releases content in the application but includes restrictions on enabling that content, such as when users must pay for content or when content is made available only after a certain point in time or after a certain point in a game is achieved. For users, this means every piece of content added, regardless of if the user actually purchased that content, is downloaded to their device, which consumes network bandwidth and disk space. Furthermore, the user is also forced to receive updates to the content they do not intend or expect to ever use.

To create downloadable content or some optional content, current platforms requires developers to make an update to the main application. This makes it especially difficult for publishers who contract application content out to third parties to provide optional content since this content require updating the application itself

Current platforms do not allow developers to build an application, submit to an application store or other distribution channel, and then build separate content after the fact that can be used with the original application and submitted separately to the application store or other distribution channel. These limitations make it difficult for developers to license or otherwise monetize additional or optional content and applications.

### SUMMARY

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

An improved software distribution model according to embodiments disclosed herein allows multiple types of content, code, and applications to be distributed separately and then be joined together at a later time. For example, a first application may be distributed to users, who later obtain additional content, code, or applications that run with the first application. The additional content, code, or applications may be obtained for free, through an in-application purchase, by downloading, from disk, or any number of other scenarios. An example illustrating this improvement is a video-playing application that might has optional content for video editing, which can be purchased, downloaded, or received separately by the user before, during, or after the original video-playing application is obtained.

A computer-implemented method comprises executing a first application package in a runtime having a first application security context, identifying a dependency element in a second application package, and if the dependency element is associated with the first application package, then executing the second application package within the runtime and security context for the first application package. Additional application packages, code, or content may also be executing within the runtime and security context for the first application package. The additional application packages, code, or content each comprise a dependency element that identifies the first application package. For example, the first application package may be a main application, and the second and additional application packages may be optional add-on packages.

The method may further comprise loading the second application package within the runtime and security context for the first application package without stopping execution of the first application package.

The method may further comprise downloading the second application package while the first application package is executing.

The method may further comprise determining if one or more additional application packages comprise a dependency element, and for any of the one or more additional application packages having a dependency element that is associated with the first application package, executing those additional application packages within the runtime and security context for the first application package.

The first application package and the second application package may have their own entitlements, wherein the entitlements comprise, for example, license terms, package names, stock keeping unit (SKU), and an application lifetime.

The first application package may be configured to run on a plurality of devices, and the second application package may be associated with a subset of the plurality of devices.

The dependency element may identify a publisher or developer for the first application package that is different from the second application package's publisher or developer. The dependency element may identify a plurality of application packages that can function as first application packages.

The method may further comprise automatically ending execution of the second application package when the execution of the first application package ends.

A system comprises a processor executing a plurality of applications, a first application package executing in a runtime having a first application security context on the processor, and a second application package executing on the processor within the runtime and security context for the first application package, wherein the second application package comprises a dependency element that identifies the first application package. Additional application packages, code, or content may also be executing on the processor within the runtime and security context for the first application package. The additional application packages, code, or content each comprise a dependency element that identifies the first application package.

The second application package may be loaded within the runtime and security context for the first application package without stopping execution of the first application package.

The system may further comprise a system memory configured to store computer-executable instructions associated with application packages, wherein the second application package is downloaded to the system memory while the first application package is executing on the processor.

The system may further comprise one or more additional application packages executing on the processor within the runtime and security context for the first application package, wherein the one or more additional application packages each comprise a dependency element that identifies the first application package.

The first application package and the second application package each have their own entitlements.

The dependency element may identify a publisher or developer for the first application package that is different from the second application package's publisher or developer. The dependency element may identify a plurality of application packages that can function as first application packages.

In other embodiments, a system for enforcing limitations on application execution comprises a system memory for storing files for a main application package and files for a plurality of optional application packages, wherein the optional application packages each comprise a dependency element that identifies one or more intended main application package; and a processor having a runtime and security context configured to support execution of the main application package, wherein one or more optional application packages execute on the processor within the runtime and security context with the first application package if the one or more optional application package's dependency element identifies the main application package. The main application package and the plurality of optional application packages each have their own entitlements. The plurality of optional application packages may identify one or more approved devices.

### DRAWINGS

To further clarify the above and other advantages and features of embodiments of the present invention, a more particular description of embodiments of the present invention will be rendered by reference to the appended drawings. It is appreciated that these drawings depict only typical embodiments of the invention and are therefore not to be considered limiting of its scope. The invention will be described and explained with additional specificity and detail through the use of the accompanying drawings in which:

FIG. 1 is a block diagram of a system for distributing universal applications that are composed of one or more sub-component universal applications.

FIG. 2 is a block diagram illustrating an example universal applications composed of one or more sub-component universal applications.

FIG. 3 is a block diagram illustrating how the components appear at runtime.

FIG. 4 is a flowchart illustrating a computer-implemented method for executing universal applications composed of one or more sub-component universal applications according to an example embodiment.

FIG. 5 illustrates an example of a suitable computing environment on which the examples of FIGS. 1-4 may be implemented to execute universal applications composed of one or more sub-component universal applications.

### DETAILED DESCRIPTION

A main universal application can be composed of multiple universal applications, each with their own identity, entitlement, language resources, etc. that provide additional functionality to the main universal application. Each additional universal application may be managed (e.g., installed, updated, uninstalled, moved, and stored) independently. All of the universal applications run under the context of the main universal application. For example, the application data is written under the main universal application's data folder. Furthermore, this model allows for multiple publishers to collaborate on a single universal application experience wherein different parts can be made by different publishers while being distributed as a single logical application. Furthermore, developers may create optional universal applications that work with multiple main universal applications from different developers. For example, downloadable content, such as maps or songs, may be used by multiple game applications from different publishers.

An optional universal application may target a particular device or device family, while the main universal application package works with all device platforms. Using this functionality, developers may build custom experiences for particular devices without requiring a new main universal application.

Each sub-componentized universal application may be developed and managed individually. For example, optional universal applications may be created, packaged, submitted, installed, updated, moved, removed, and/or licensed separately from the main universal application. The sub componentized universal applications are different from multi-application packages that are deployed together and that are built together.

The componentized universal applications can merge together under a single universal application identity to create a seamless runtime experience in which code and background services can be loaded.

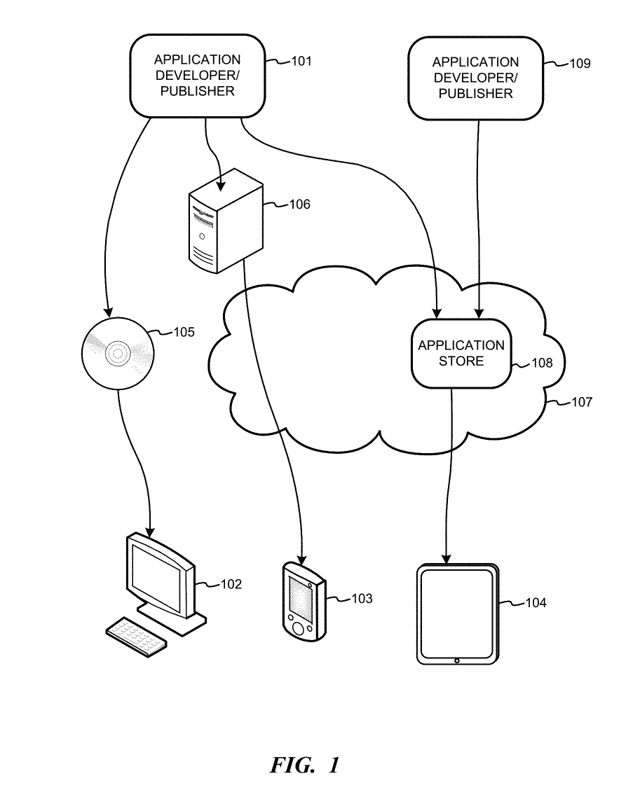

FIG. 1 is a block diagram of a system for distributing universal applications that are composed of one or more sub-component universal applications. The sub-component universal applications provide additional functionality to the main universal application. The sub-component universal applications have their own identity, entitlement, and resources. An application developer or publisher 101 creates the main universal application and/or associated optional universal applications. The main and optional universal applications are distributed to end-user devices, such as a personal computer 102, smartphone 103, or tablet 104. The universal applications may be distributed using traditional methods, such as on CD/DVD 105 or using other physical media. An end-user device, such as personal computer 102, may load the application from the CD/DVD 105 using a disk drive or other media reader.

Alternatively or additionally, application publisher 101 may load the universal applications to a server 106 that is hosted by the publisher or a third party. An end-user device, such as smartphone 103, may access the server 106 via a public or private network 107 and download the universal applications. In another embodiment, application publisher 101 may provide universal applications to an application store 108, which may be, for example, hosted on a widely available cloud service. An end-user device, such as tablet 104, may access the application store 108 via network 107 and download desired universal applications.

Another application publisher 109 may develop universal applications that are associated with the universal applications created by publisher 101. For example, application publisher 109 may create universal applications that comprise optional, add-on content for a main gaming universal application developed by publisher 101. Application publisher 109 may provide the optional universal application to application store 108. If the user on device 104 desires the additional content, then that user may access the application store 108 and download the optional universal application. Each application package on the application store 108 may be identified with a unique package name, SKU, or other identifier.

It will be understood that main and optional universal applications may be distributed to end-user devices in any number ways now known or later developed and that the system shown in FIG. 1 is simplified for illustration purposes. Moreover, in addition to the end-user devices illustrated in FIG. 1, any other end-user device may access, download, and run universal applications composed of one or more sub-component universal applications. Furthermore, additional application publishers or developers may provide universal applications to application store 108 or to other application stores accessible via network 107 or any other private or public network (not shown).

FIG. 2 is a block diagram illustrating an example universal applications composed of one or more sub-component universal applications. A device loads a main universal application package 201 and may load one or more optional application packages 202, 203. The main application package 201 comprises a group of application files 204, including an application manifest 205. The application manifest 205 may be, for example, an XML file that describes the contents of main application package 201 and specifies how the contents 204 of the package are mapped into a directory structure.

The XML manifest 205 contains three sections in one embodiment—package metadata, package contents, and package layouts. The package metadata is a key/value store, where the keys are strings and the values are strings. The package contents describe the files 204 that comprise the package 201. The package layouts map content resources to a particular layout of files and directories. The XML manifest file 205 may be named according to the appropriate convention for the device or platform, such as “platform.xml” or “manifest.xml”. However, the XML manifest can be any file in the archive 204 as long as the relationship points to the XML manifest file and the XML manifest file conforms to the schema.

Optional application packages 202 also comprise application files 206, which include an application manifest 207. Application files 206 and application manifest 207 in the optional application packages 202 are similar to the corresponding files in main application package 201. However, the application manifest in optional application packages 202 include code or text identifying dependencies to main application package 201 and/or to other main application packages.

The following text illustrates an example element from the manifest file in an optional application package. The element begins with the <Dependencies> start-tag, and ends with the </Dependencies> end-tag. This element defines the main package dependency for the optional package.

<Dependencies>
<TargetDeviceFamily Name=“Windows.Universal” MinVersion=

“10.0.14000.0” MaxVersionTested=“12.0.0.0”/>

<uap3:MainPackageDependency Name=“MyApp.Main” Publisher=

“MyMainPublisher”/>

</Dependencies>

The Dependencies element includes attributes to identify the target device family, the main package, and the main application publisher associated with the optional application package. The publisher attribute is optional. If no publisher value is specified, then the publisher for the dependency is assumed to the publisher of the optional application package.

It is possible to identify multiple target device families, main applications, and publishers in the Dependencies element. This allows one optional application package to work with different types of main applications or different version of the same main application.

The presence of the Dependencies element tells the system that the identified main application must be present. If the appropriate main application is not present, then the system will not load or run the optional application package. The main application must be loaded before the system will register the dependent optional application packages.

The optional application package may be encrypted. If the main application is loaded and the optional application package has the appropriate Dependencies element, then the system will decrypt the optional application package at run time as it is used.

With universal applications, developers can release an application and provide additional content, either with the initial release or at a later time. The additional content may be in the form of an optional application package that can be acquired as an in-application purchase or as a purchase from an application store. The optional application package may be, for example, downloadable content (DLC) for a gaming application; free support data, such as mapping data, for the main application; or data that is specific to a set of hardware capabilities for a particular end-user device. By providing universal applications that are composed of one or more sub-component universal applications, users save time, bandwidth, and disk storage while getting the best application experience that developers can provide.

By including the one or more sub-component universal applications, developers can portion out their application into application packages and content packages, which allows users to download the content on demand as it is needed. Additionally, application publishers can release an application and subsequently release some DLC or optional content without having to release an update to the main application itself. Instead, developers can build a separate content package that can be submitted to the application store and acquired by users.

In one embodiment, developers may convert existing applications with built-in optional content to a main universal application and one or more sub-component universal applications that comprise the optional content. The user experience impact for sub-component universal applications will be the same as for traditional applications having a single package. Similarly, there is no impact on performance when comparing the sub-componentized universal applications to traditional single-package applications.

The sub-componentized universal applications allow developers to manage (e.g., enumerate, update, license) all content on the user's behalf. Developers can add new and/or updated content to an application by releasing a new optional application package without having to rebuild the main application and without impacting the main application. The optional application package content follows the same licensing rules as the main application (e.g. concurrency, sharing, revocation, and ceasing distribution). The optional content can be licensed separately from the main application itself

Application content is always dynamic using the sub-componentized universal applications. If a system configuration changes, then new content for that configuration can be downloaded. Likewise, content that is no longer needed can be removed following a configuration change.

Existing applications do not have the ability to pull unique sub-content entities into that main application. The improvement disclosed herein is the ability to create a universal application that is made up of multiple packages. The separate packages may be DLLs, content, or other applications that are downloadable and able to be consumed by the main application that was originally downloaded. And at runtime the sub-component or optional applications are seen as part of the main application. The optional applications have their own entitlements. Entitlements are the rights and privileges associated with an application package. They have their own licensing, they are uniquely identified in the application store, and they have a unique package name.

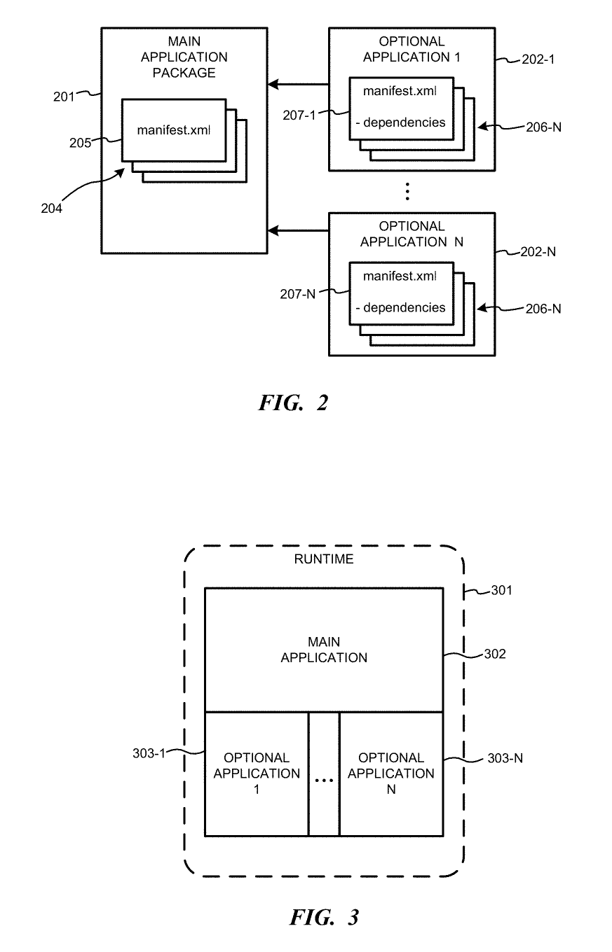

FIG. 3 is a block diagram illustrating how the components appear at runtime. Within runtime 301, the main application 302 and the optional applications 303 appear as if they are a single application to the device because the sub-components all run in the same security context.

Alternatively, a developer may create multiple applications so that one or more of the separate downloadable packages 302 could be an application within themselves. For example, in a gaming context, the user can download maps as content and may also download a game editor or a map editor. The editor would be a separate application that the user could purchase and download, then create their own content locally.

The optional application packages get all of the benefits, advantages, and features of the main application packages. The main application and the optional application run within the same security boundary. They are separate packages, but they act as one at runtime. The optional application package is registered with the system. So the new functionality is now registered and the rest of the operating system is made aware that the optional application package is a viable entry point.

The lifetimes of the main and optional applications do not need to be tied together. The optional package may be removed without removing the main application package, such as if the user desires more disk space or no longer wants the optional package. If the main application is removed, then the associated optional application packages may also be removed in some scenarios.

When adding optional application packages, the main application does not need to be torn down by the system. At runtime, if the main application is started up and then the user purchases the optional application package, then the optional application package is downloaded and installed while the main application is still running. For example, if a game application is running and the user purchases a new map, the main application does not have to be torn down and restarted in order to add the map. This provides for a better user experience because there is no servicing to the main package when the optional application package is added. The new optional application package is also added under the existing security context of the main application.

This is an improvement over existing systems. If a developer wants to create an update to their application in current system, such as by add new content, then the developer would have to update the entire application. For example, the developer would have to put in an extra DLL or an asset file that holds all the information for the new content. After the developer adds that new material into their main application, then they have to create some entitlement for the user to purchase in order to access the revised application. So that means that the developer has a separate entity, but there is no backing content or DLL with it. The developer in current systems must update their main application to change the available content.

Using the universal applications that are composed of a main application and one or more sub-component universal applications, as disclosed herein, allows developers to pull out the DLL, the entitlement, and all new content into a unique package. That package can then be made available on the application store.

In another embodiment, publishers may contract out content to other publishers or developers to create assets for a main application. This allows that publisher to subcontract content creation. The subcontract publisher creates separate optional application packages that can be passed back to the main developer for uploading to an application store or to users.

The main application may be directed to any subject matter, such as a gaming application or an office productivity suite. The optional packages may be created with content that is appropriate for the main application, such as new maps for a gaming application or new word processing or spreadsheet features for the office productivity suite. The optional packages use the common, shared DLLs and features via the main application and have the same security context so they can share data between the sub-component applications and the main application.

The optional packages may be individually licensed, purchased and downloaded entities. The end user can add these other entities when needed or desired any time after loading the main application. There may be different licensing for different optional applications because they are individual packages. The different license agreements may have different dates and terms, for example, and may allow the optional content to be used with more than main application.

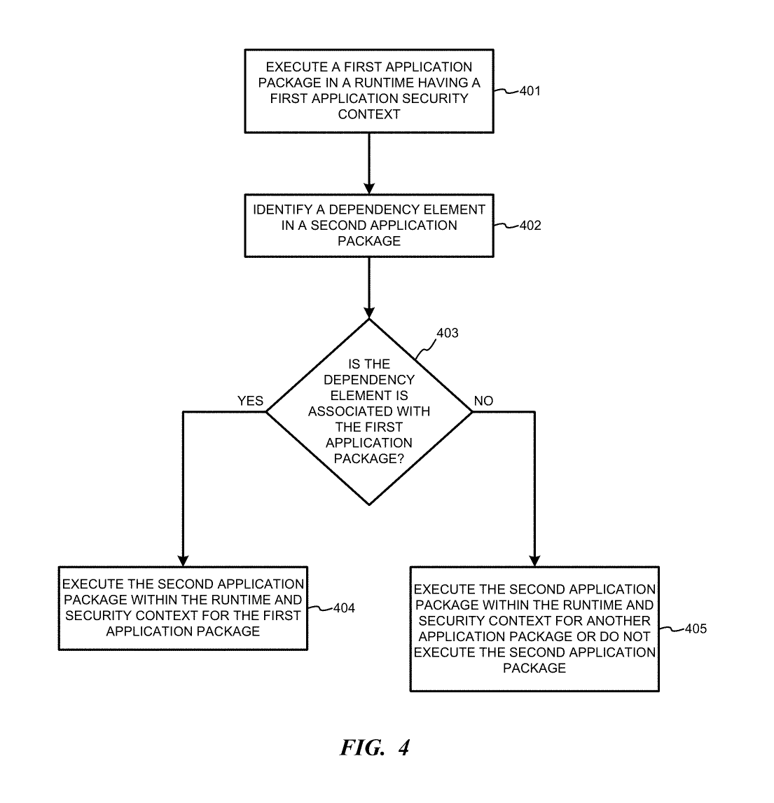

FIG. 4 is a flowchart illustrating a computer-implemented method for executing universal applications composed of one or more sub-component universal applications according to an example embodiment. In step 401, a first application package is executed in a runtime having a first application security context. In step 402, a dependency element is identified in a second application package. In step 403, the method determines whether the dependency element is associated with the first application package. If the dependency element is associated with the first application, then in step 404 the second application package is executed within the runtime and security context for the first application package. Otherwise, the second application package is executed within the runtime and security context for another application package or not executed at all in step 405. Execution of the second application package automatically ends when the execution of the first application package ends.

The second application package may be downloaded while the first application package is executing. The second application package may comprise a software application, code, or content. The second application package may be loaded within the runtime and security context for the first application package without stopping execution of the first application package. The first application package and the second application package may each have their own entitlements. The entitlements comprise one or more of license terms, package names, SKU, and an application lifetime.

The method may further comprise determining if one or more additional application packages comprise a dependency element, and for any of the one or more additional application packages having a dependency element that is associated with the first application package, executing those additional application packages within the runtime and security context for the first application package. The first application package may be configured to run on a plurality of devices, and the second application package may be associated with a subset of the plurality of devices.

The dependency element may identify a publisher or developer for the first application package that is different from the second application package's publisher or developer. The dependency element may identify a plurality of application packages that can function as first application packages.

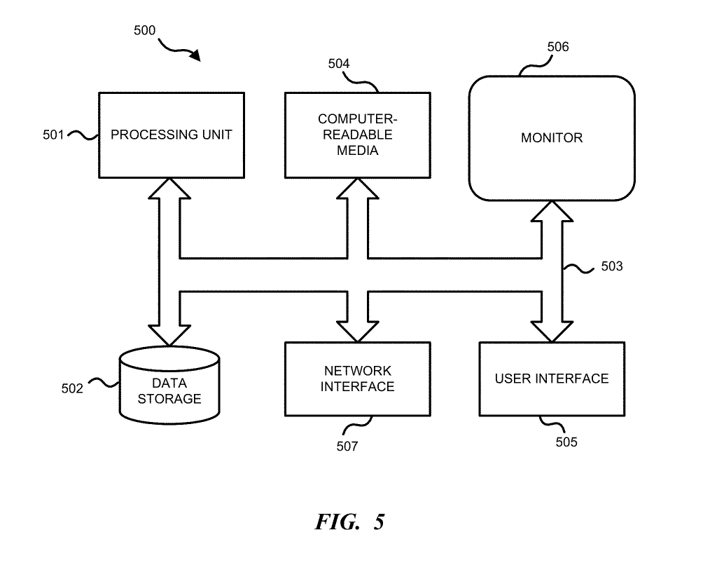

FIG. 5 illustrates an example of a suitable computing environment 500 on which the examples of FIGS. 1-4 may be implemented to execute universal applications composed of one or more sub-component universal applications. The computing system environment 500 is only one example of a suitable computing environment and is not intended to suggest any limitation as to the scope of use or functionality of the invention. The invention is operational with numerous other general purpose or special purpose computing system environments or configurations. Examples of well-known computing systems, environments, and/or configurations that may be suitable for use with the invention include, but are not limited to: personal computers (PC), server computers, hand-held or laptop devices, tablet devices, game consoles, smartphones, multiprocessor systems, microprocessor-based systems, set top boxes, programmable consumer electronics, network PCs, minicomputers, mainframe computers, distributed computing environments that include any of the above systems or devices, and the like.

The invention may be described in the general context of computer-executable instructions, such as program modules, being executed by a computer. Generally, program modules include routines, programs, objects, components, data structures, and so forth, which perform tasks or implement abstract data types. The invention may also be practiced in distributed computing environments where tasks are performed by remote processing devices that are linked through a communications network. In a distributed computing environment, program modules may be located in local and/or remote computer storage media including memory storage devices.

With reference to FIG. 5, an exemplary system for implementing various aspects of the invention may include a general-purpose computing device in the form of a computer 500. Components may include, but are not limited to, various hardware components, such as processing unit 501, data storage 502, such as a system memory, and system bus 503 that couples various system components including the data storage 502 to the processing unit 501. The system bus 503 may be any of several types of bus structures including a memory bus or memory controller, a peripheral bus, and a local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus also known as Mezzanine bus.

The computer 500 typically includes a variety of computer-readable media 504. Computer-readable media 504 may be any available media that can be accessed by the computer 500 and includes both volatile and nonvolatile media, and removable and non-removable media, but excludes propagated signals. By way of example, and not limitation, computer-readable media 504 may comprise computer storage media and communication media. Computer storage media includes volatile and nonvolatile, removable, and non-removable media implemented in any method or technology for storage of information such as computer-readable instructions, data structures, program modules or other data. Computer storage media includes, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can be accessed by the computer 500. Communication media typically embodies computer-readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of the any of the above may also be included within the scope of computer-readable media. Computer-readable media may be embodied as a computer program product, such as software stored on computer storage media.

The data storage or system memory 502 includes computer storage media in the form of volatile and/or nonvolatile memory such as read only memory (ROM) and random access memory (RAM). A basic input/output system (BIOS), containing the basic routines that help to transfer information between elements within computer 500, such as during start-up, is typically stored in ROM. RAM typically contains data and/or program modules that are immediately accessible to and/or presently being operated on by processing unit 501. By way of example, and not limitation, data storage 502 holds an operating system, application programs, and other program modules and program data.

Data storage 502 may also include other removable/non-removable, volatile/nonvolatile computer storage media. By way of example only, data storage 502 may be a hard disk drive that reads from or writes to non-removable, nonvolatile magnetic media, a magnetic disk drive that reads from or writes to a removable, nonvolatile magnetic disk, and an optical disk drive that reads from or writes to a removable, nonvolatile optical disk such as a CD ROM or other optical media. Other removable/non-removable, volatile/nonvolatile computer storage media that can be used in the exemplary operating environment include, but are not limited to, magnetic tape cassettes, flash memory cards, digital versatile disks, digital video tape, solid state RAM, solid state ROM, and the like. The drives and their associated computer storage media, described above and illustrated in FIG. 5, provide storage of computer-readable instructions, data structures, program modules and other data for the computer 500.

A user may enter commands and information through a user interface 505 or other input devices such as a game controller, touchscreen, tablet, electronic digitizer, a microphone, keyboard, and/or pointing device, commonly referred to as mouse, trackball, or touch pad. Other input devices may include a joystick, game pad, satellite dish, scanner, or the like. Additionally, voice inputs, gesture inputs using hands or fingers, or other natural user interface (NUI) may also be used with the appropriate input devices, such as a microphone, camera, tablet, touch pad, glove, or other sensor. These and other input devices are often connected to the processing unit 501 through a user input interface 505 that is coupled to the system bus 503, but may be connected by other interface and bus structures, such as a parallel port, game port or a universal serial bus (USB). A monitor 506 or other type of display device is also connected to the system bus 503 via an interface, such as a video interface. The monitor 506 may also be integrated with a touch-screen panel or the like. Note that the monitor and/or touch screen panel can be physically coupled to a housing in which the computing device 500 is incorporated, such as in a tablet-type personal computer. In addition, computers such as the computing device 500 may also include other peripheral output devices such as speakers and printer, which may be connected through an output peripheral interface or the like.

The computer 500 may operate in a networked or cloud-computing environment using logical connections 507 to one or more remote devices, such as a remote computer. The remote computer may be a personal computer, a server, a router, a network PC, a peer device, or other common network node, and typically includes many or all of the elements described above relative to the computer 500. The logical connections depicted in FIG. 5 include one or more local area networks (LAN) and one or more wide area networks (WAN), but may also include other networks. Such networking environments are commonplace in offices, enterprise-wide computer networks, intranets, and the Internet.

When used in a networked or cloud-computing environment, the computer 500 may be connected to a public or private network through a network interface or adapter 507. In some embodiments, a modem, transceiver, network interface card, or other means for establishing communications over the network. The network interface 507, which may be internal or external, may be connected to the system bus 503 via the network interface 507 or other appropriate mechanism. A wireless networking component such as comprising an interface and antenna may be coupled through a suitable device such as an access point or peer computer to a network. In a networked environment, program modules depicted relative to the computer 500, or portions thereof, may be stored in the remote memory storage device. It may be appreciated that the network connections shown are exemplary and other means of establishing a communications link between the computers may be used.

An example computer-implemented method comprises executing a first application package in a runtime having a first application security context; identifying a dependency element in a second application package; and if the dependency element is associated with the first application package, then executing the second application package within the runtime and security context for the first application package, wherein the second application package comprises a software application, code, or content.

The example method may further comprise loading the second application package within the runtime and security context for the first application package without stopping execution of the first application package.

The example method may further comprise downloading the second application package while the first application package is executing.

The example method may further comprise determining if one or more additional application packages comprise a dependency element; and for any of the one or more additional application packages having a dependency element that is associated with the first application package, executing those additional application packages within the runtime and security context for the first application package.

The first application package and the second application package may each have their own entitlements.

The entitlements may comprise one or more of license terms, package names, stock keeping unit (SKU), and an application lifetime.

The first application package may be configured to run on a plurality of devices, and wherein the second application package is associated with a subset of the plurality of devices.

The dependency element may identify a publisher or developer for the first application package that is different from the second application package's publisher or developer.

The dependency element may identify a plurality of application packages that can function as first application packages.

The example method may further comprise automatically ending execution of the second application package when the execution of the first application package ends.

An example system comprises a processor executing a plurality of applications; a first application package executing in a runtime having a first application security context on the processor; and a second application package executing on the processor within the runtime and security context for the first application package, wherein the second application package comprises a dependency element that identifies the first application package.

The second application package in the example system may be loaded within the runtime and security context for the first application package without stopping execution of the first application package.

The example system may further comprise a system memory configured to store computer-executable instructions associated with application packages, wherein the second application package is downloaded to the system memory while the first application package is executing on the processor.

The example system may further comprise one or more additional application packages executing on the processor within the runtime and security context for the first application package, wherein the one or more additional application packages each comprise a dependency element that identifies the first application package.

The first application package and the second application package in the example system may each have their own entitlements.

The dependency element in the example system may identify a publisher or developer for the first application package that is different from the second application package's publisher or developer. The dependency element in the example system may identify a plurality of application packages that can function as first application packages.

The second application package in the example system may be automatically ended when the execution of the first application package ends.

An example system for enforcing limitations on application execution, comprises a system memory for storing files for a main application package and files for a plurality of optional application packages, wherein the optional application packages each comprise a dependency element that identifies one or more intended main application package; and a processor having a runtime and security context configured to support execution of the main application package, wherein one or more optional application packages execute on the processor within the runtime and security context with the first application package if the one or more optional application package's dependency element identifies the main application package.

In the example system, the main application package and the plurality of optional application packages may each have their own entitlements, and the plurality of optional application packages may identify one or more approved devices.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

What is claimed is:

1. A computer-implemented method, comprising:
executing a first application package in a runtime having a first application security context;
identifying a dependency element in a second application package; and
if the dependency element is associated with the first application package, then executing the second application package within the runtime and security context for the first application package, wherein the second application package comprises a software application, code, or content.

2. The method of claim 1, further comprising:
loading the second application package within the runtime and security context for the first application package without stopping execution of the first application package.

3. The method of claim 1, further comprising:
downloading the second application package while the first application package is executing.

4. The method of claim 1, further comprising:
determining if one or more additional application packages comprise a dependency element; and
for any of the one or more additional application packages having a dependency element that is associated with the first application package, executing those additional application packages within the runtime and security context for the first application package.

5. The method of claim 1, wherein the first application package and the second application package each have their own entitlements.

6. The method of claim 5, wherein the entitlements comprise one or more of license terms, package names, stock keeping unit (SKU), and an application lifetime.

7. The method of claim 1, wherein the first application package is configured to run on a plurality of devices, and wherein the second application package is associated with a subset of the plurality of devices.

8. The method of claim 1, wherein the dependency element identifies a publisher or developer for the first application package that is different from the second application package's publisher or developer.

9. The method of claim 1, wherein the dependency element identifies a plurality of application packages that can function as first application packages.

10. The method of claim 1, further comprising:
automatically ending execution of the second application package when the execution of the first application package ends.

11. A system, comprising:
a processor executing a plurality of applications;
a first application package executing in a runtime having a first application security context on the processor; and
a second application package executing on the processor within the runtime and security context for the first application package, wherein the second application package comprises a dependency element that identifies the first application package.

12. The system of claim 11, wherein the second application package is loaded within the runtime and security context for the first application package without stopping execution of the first application package.

13. The system of claim 11, further comprising:
a system memory configured to store computer-executable instructions associated with application packages, wherein the second application package is downloaded to the system memory while the first application package is executing on the processor.

14. The system of claim 11, further comprising:
one or more additional application packages executing on the processor within the runtime and security context for the first application package, wherein the one or more additional application packages each comprise a dependency element that identifies the first application package.

15. The system of claim 11, wherein the first application package and the second application package each have their own entitlements.

16. The system of claim 11, wherein the dependency element identifies a publisher or developer for the first application package that is different from the second application package's publisher or developer.

17. The system of claim 11, wherein the dependency element identifies a plurality of application packages that can function as first application packages.

18. The system of claim 1, wherein execution of the second application package is automatically ended when the execution of the first application package ends.

19. A system for enforcing limitations on application execution, comprising:
a system memory for storing files for a main application package and files for a plurality of optional application packages, wherein the optional application packages each comprise a dependency element that identifies one or more intended main application package; and
a processor having a runtime and security context configured to support execution of the main application package, wherein one or more optional application packages execute on the processor within the runtime and security context with the first application package if the one or more optional application package's dependency element identifies the main application package.

20. The system of claim 19, wherein the main application package and the plurality of optional application packages each have their own entitlements, and wherein the plurality of optional application packages identifies one or more approved devices.
